(19) United States
(12) Patent Application Publication
(10) Pub. No.: US 2019/0031691 A1
(43) Pub. Date: Jan. 31, 2019

(54) HYDROPHILIC SILANES

(71) Applicants: Dow Silicones Corporation, Midland, MI (US); Dow Corning Toray Co., Ltd., Tokyo (JP)

(72) Inventors: Michael Salvatore FERRITTO, Midland, MI (US); Lenin James PETROFF, Bay City, MI (US); Tatsuo SOUDA, Chiba (JP)

(21) Appl. No.: 16/073,372

(22) PCT Filed: Feb. 21, 2017
(86) PCT No.: PCT/US2017/018612

§ 371 Date: Jul. 27, 2018

Related U.S. Application Data
(60) Provisional application No. 62/328,124, filed on Apr. 27, 2016.

(51) Int. Cl. C07F 7/18

(52) U.S. Cl. CPC C07F 7/1876; C07F 7/1804

(57) ABSTRACT

An organosilane having formula (I) X-A-Z, wherein X is —SiR⁴ₙR²₍₃₋ₙ₎, where each R⁴ is independently OR¹ or halogen, wherein each R¹ is independently hydrogen or C₁₋₁₀ hydrocarbyl and each R² is independently C₁₋₁₀ hydrocarbyl, and n is from 1 to 3, A is C₁₋₁₀ hydrocarbylene, wherein the backbone of the hydrocarbylene is substituted and the substitution comprises one or more oxygen atoms, one or more nitrogen atoms, or carbonyl, Z is a sugar group, a diglycerol group, a polyglycerol group, or a xylitol group, methods of making the organosilane of formula (I), and applications of the organosilane of formula (I).

### CROSS REFERENCE TO RELATED APPLICATIONS

This application claims the benefit of U.S. Provisional Patent Application No. 62/328,124 filed 27 Apr. 2016 under 35 U.S.C. § 119 (e). U.S. Provisional Patent Application No. 62/328,124 is hereby incorporated by reference.

### TECHNICAL FIELD

The present invention generally relates to an organosilanes useful in rendering surfaces hydrophilic, methods of making the organosilanes, compositions comprising the organosilanes, methods of treating surfaces with the compositions comprising the organosilanes, and the treated surfaces.

### BACKGROUND

Silanes have a variety of known uses. For example, they can be used as monomers in making, elastomers, polymers and resins, as coupling agents, additives for various compositions such as detergents, household and personal care formulations, and as surface treating agents for rendering surfaces hydrophilic. Some silanes have multiple uses in a variety of applications.

Silanes used for the treatment of surfaces to render the surfaces hydrophilic have known hydrophilic groups bound to the silicon atom of the silane. Examples of these hydrophilic groups are polyethylene oxide and polypropylene oxide. However, polyethylene oxide and polypropylene oxide have some unwanted properties.

We see a long-felt need in the industries for organosilanes useful in rendering surfaces hydrophilic but that do not comprise either polyethylene oxide or polypropylene oxide. We think organosilanes not comprising either polyethylene oxide or polypropylene oxide and which render surfaces hydrophilic may enable greater formulation latitude in providing better compatibility with other materials and may have improved performance in some areas.

Silanes have been made by various methods including the direct process, hydrosilylation, and Grignard reactions.

### SUMMARY OF THE INVENTION

We have discovered a hydrophilic organosilane. The present invention is directed to each of the following embodiments:

An organosilane having the formula (I) X-A-Z, wherein X is —SiR⁴ₙR²₍₃₋ₙ₎, where each R⁴ is independently OR¹ or halogen, each R¹ is independently hydrogen or C₁₋₁₀ hydrocarbyl and each R² is independently C₁₋₁₀ hydrocarbyl, and n is from 1 to 3, A is C₁₋₁₀ hydrocarbylene, wherein the backbone of the hydrocarbylene is substituted and the substitution comprises one or more oxygen atoms, one or more nitrogen atoms, or carbonyl, Z is a sugar group, a diglycerol group, a polyglycerol group, or a xylitol group.

Compositions comprising the organosilane.

Methods of making the organosilane and the organosilane produced by the method.

Methods of making polysiloxanes from the organosilane.

Treatment compositions comprising the product of the hydrolysis and/or condensation of the organosilane.

A method of treating a surface with the organosilane.

A hydrophilized substrate, comprising a substrate treated with the organosilane, a composition comprising the organosilane, or the treatment composition comprising the product of the hydrolysis and/or condensation of the organosilane.

Cosmetic compositions comprising a hydrophilized powder.

The organosilane comprises no polyethylene oxide nor polypropylene oxide; renders surfaces hydrophilic; provides improved dispersibility of certain powders, transparency, UV protection, contact angle, among other properties.

### DETAILED DESCRIPTION OF THE INVENTION

The Brief Summary and Abstract are incorporated here by reference. The invention embodiments, uses and advantages summarized above are further described below.

Aspects of the invention are described herein using various common conventions. For example, all states of matter are determined at 25° C. and 101.3 kPa unless indicated otherwise. All % are by weight unless otherwise noted or indicated. All % values are, unless otherwise noted, based on total amount of all ingredients used to synthesize or make the composition, which adds up to 100%. Any Markush group comprising a genus and subgenus therein includes the subgenus in the genus, e.g., in “R is hydrocarbyl or alkenyl,” R may be alkenyl, alternatively R may be hydrocarbyl, which includes, among other subgenuses, alkenyl. For U.S. practice, all U.S. patent application publications and patents referenced herein, or a portion thereof if only the portion is referenced, are hereby incorporated herein by reference to the extent that incorporated subject matter does not conflict with the present description, which would control in any such conflict.

Aspects of the invention are described herein using various patent terms. For example, “alternatively” indicates a different and distinct embodiment. “Comparative example” means a non-invention experiment. “Comprises” and its variants (comprising, comprised of) are open ended. “Consists of” and its variants (consisting of) is closed ended. “Contacting” means bringing into physical contact. “May” confers a choice, not an imperative. “Optionally” means is absent, alternatively is present.

Aspects of the invention are described herein using various chemical terms. The meanings of said terms correspond to their definitions promulgated by IUPAC unless otherwise defined herein. For convenience, certain chemical terms are defined.

The term “halogen” means fluorine, chlorine, bromine or iodine, unless otherwise defined.

The term “IUPAC” refers to the International Union of Pure and Applied Chemistry.

“Periodic Table of the Elements” means the version published 2011 by IUPAC.

An organosilane having formula (I) X-A-Z, wherein X is —SiR⁴ₙR²₍₃₋ₙ₎, where each R⁴ is independently OR¹ or halogen, wherein each R¹ is independently hydrogen or C₁₋₁₀ hydrocarbyl and each R² is independently C₁₋₁₀ hydrocarbyl, and n is from 1 to 3, A is C₁₋₁₀ hydrocarbylene, wherein the backbone of the hydrocarbylene is substituted and the substitution comprises one or more oxygen atoms, one or more nitrogen atoms, or carbonyl, Z is a sugar group, a diglycerol group, a polyglycerol group, or a xylitol group. Examples of halogen represented by R⁴ include F, Cl, Br, and I, alternatively F, Cl, and Br, alternatively Cl or Br, alternatively Cl.

The hydrocarbyl groups represented by R¹ and R² typically have from 1 to 10, alternatively from 1 to 6 carbon atoms, alternatively 1 to 4 carbon atoms, alternatively 1 to 3 carbon atoms, alternatively 1 or 2 carbon atoms, alternatively 2 to 6 carbon atoms, alternatively 2 or three carbon atoms. Acyclic hydrocarbyl groups containing at least three carbon atoms can have a branched or unbranched structure. Examples of hydrocarbyl groups include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and napthyl; alkaryl, such as tolyl and xylyl; arakyl, such as benzyl and phenethyl; alkenyl, such as vinyl, allyl, and propenyl; aralkenyl, such as styryl and cinnamyl; and alkynyl, such as ethynyl and propynyl.

Hydrocarbylene groups represented by A typically have from 1 to 10 carbon atoms, alternatively from 2 to 10 carbon atoms, alternatively from 1 to 6 carbon atoms, alternatively from 2 to 6 carbon atoms, alternatively from 1 to 3 carbon atoms, alternatively 2 or 3 carbon atoms, alternatively from 3 to 10 carbon atoms, alternatively from 3 to 6 carbon atoms, alternatively 3 carbon atoms, alternatively 6 carbon atoms, alternatively 10 carbon atoms. The backbone of the hydrocarbylene is substituted and the substitution comprises one or more oxygen atoms, one or more nitrogen atoms, or carbonyl. The hydrocarbylene group represented by A may be further substituted in addition to the substitution in reference to the backbone.

“Substitutued,” in reference to the backbone of the hydrocarbylene, means that one of the carbons of the carbon backbone is replaced by one or more atoms other than carbon or one or two carbonyl groups, alternatively one or more of O, N, or carbonyl, alternatively O, N, carbonyl, —NC(O)N—, —NC(O)O—, or —C(O)O—, alternatively O, N, carbonyl, —NC(O)N—, —NC(O)O. The substitution may be within the carbon chain or at an end of the carbon chain. For example, a hydrocarbylene comprising 3 carbon atoms and substituted with oxygen includes, but is not limited to, the following structures: —CH₂CH₂CH₂O— and —CH₂OCH₂CH₂—, and a hydrocarbylene having one carbon atom and substituted with oxygen means —CH₂O—.

“Substituted,” other than in reference to the backbone of the hydrocarbylene, means that a hydrogen atom of a hydrocarbyl or hydrocarblene group is substituted with a group or atom other than hydrogen or carbon, alternatively a hydroxyl, amine or oxygen, wherein the oxygen is part of a carbonyl group.

Acyclic hydrocarbylene groups containing at least three carbon atoms can have a branched or unbranched structure Examples of hydrocarbylene groups with the backbone of the hydrocarbylene substituted and represented by A include, but are not limited to, diyl groups formed by removing two hydrogen atoms from an alkane, such as methane (e.g., 1,1-methane-diyl), ethane, propane, 1-methylethane, butane, 1-methylpropane, 2-methylpropane, 1,1-dimethylethane, pentane, 1-methylbutane, 1-ethylpropane, 2-methylbutane, 3-methylbutane, 1,2-dimethylpropane, 2,2-dimethylpropane, hexane, heptane, octane, nonane, and decane; from cycloalkane, such as cyclopentane (e.g., 1,3-cyclopentane-diyl), cyclohexane, and methylcyclohexane; from arene, such as benzene and napthalene; from alkarene, such as toluene and xylene; from alkene, such as ethene, propene, phenyl butene; from an aralkene, such as styrene, and 3-phenyl-2-propene; and from alkyne, such as ethyne and propyne, and wherein one or more, alternatively from 1 to 3, alternatively 1 or two, of the carbons of the hydrocarbylene backbone is substituted with O, N, carbonyl, —NC(O)N—, or —NC(O)O; and further including eugenol,

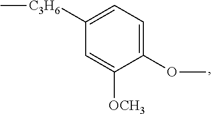

—(CH₂)ₐCH₂O—, —(CH₂)ₐCH₂OCH₂CH(OH)CH₂—, wherein z is from 0 to 6, alternatively from 1 to 3, alternatively 2.

The groups represented by Z include, but are not limited to, sugar group, a diglycerol group, a polyglycerol group, or a xylitol group. The sugar groups may be one or more sugar groups, represented by the chemical formula C₆H₁₂O₆, linked together. Examples of sugar groups represented by Z include, but are not limited to, N-methyl glucosamine (e.g., (2R,3R,4R,5S)-6-(Methylamino)hexane-1,2,3,4,5-pentol) and glucose (e.g., D-glucose), where Z is bonded and/or linked through the nitrogen or an oxygen atom to A. In one embodiment the sugar group is N-methyl glucosamine, where the group is bonded and/or linked by the nitrogen atom to A. The diglycerol and polyglycerol groups represented by Z comprise two (in the case of diglycerol) or more glycerol units linked through an oxygen atom.

The diglycerol or polyglycerol group is represented by Glyₐ, wherein Gly is R³CH₂CH(R³)CH₂R³, where each R³ independently represents hydroxyl, an oxygen atom linking to A, or an oxygen atom linking to another Gly unit, and a is an integer ≥2, alternatively an integer from 2 to 6, alternatively 2 or 3, alternatively 2, alternatively 3. In one embodiment, Glyₐ represents —OCH₂CH(OH)CH₂OCH₂CH(OH)CH2OH, —OCH(CH₂OCH₂CH(OH)CHOH)CH₂OCH₂CH(OH)CH₂OH, or —O(C3H6O2)_{b}H, wherein b is greater than 1, alternatively from 2 to 8, alternatively from 2 to 6, alternatively 2 or 3, alternatively 2 alternatively 3, alternatively Glyₐ represents —OCH₂CH(OH)CH₂OCH₂CH(OH)CH2OH, or —OCH(CH₂OCH₂CH(OH)CHOH)CH₂OCH₂CH(OH)CH₂OH.

The xylitol group is represented by Xyl, wherein Xyl is CH₂(R⁵)CH(R⁵)CH₂C(H)(R⁵)CH₂R⁵, where each R⁵ independently represents hydroxyl or an oxygen atom linking Xyl to A. An example of the xylitol group is —OCH₂CH(OH)CH₂CH(OH)CH₂(OH).

The group represented by X is —SiR⁴ₙR²₍₃₋ₙ₎, where each R⁴ is independently OR¹ or halogen, wherein each R¹ is independently hydrogen or C₁₋₁₀ hydrocarbyl and each R² is independently C₁₋₁₀ hydrocarbyl, and n is from 1 to 3, alternatively 2 or 3, alternatively 2, alternatively 3, alternatively 1. Acyclic hydrocarbyl groups containing at least three carbon atoms can have a branched or unbranched structure. Examples of hydrocarbyl groups represented by R¹ include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and napthyl; alkaryl, such as tolyl and xylyl; aralkyl, such as benzyl and phenethyl; alkenyl, such as vinyl, allyl, and propenyl; aralkenyl, such as styryl and cinnamyl; and alkynyl, such as ethynyl and propynyl. Examples of hydrocarbyl groups represented by R² are those described from R¹ above. In one embodiment R¹ is the same as R² which is methyl, alternatively ethyl.

Examples of —SiR⁴ₙR²₍₃₋ₙ₎ include, but are not limited to, trimethoxysilyl, triethoxysilyl, tripropoxysilyl, methyldimethoxysilyl, ethyldiethoxysilyl, ethyldimethoxysilyl, methyldiethoxysilyl, dim ethylmethoxysilyl, diethyldiethoxysilyl, diethylmethoxysilyl, dimethylethoxysilyl.

Examples of organosilane having formula (I), X-A-Z (I) include, but are not limited to, the following:

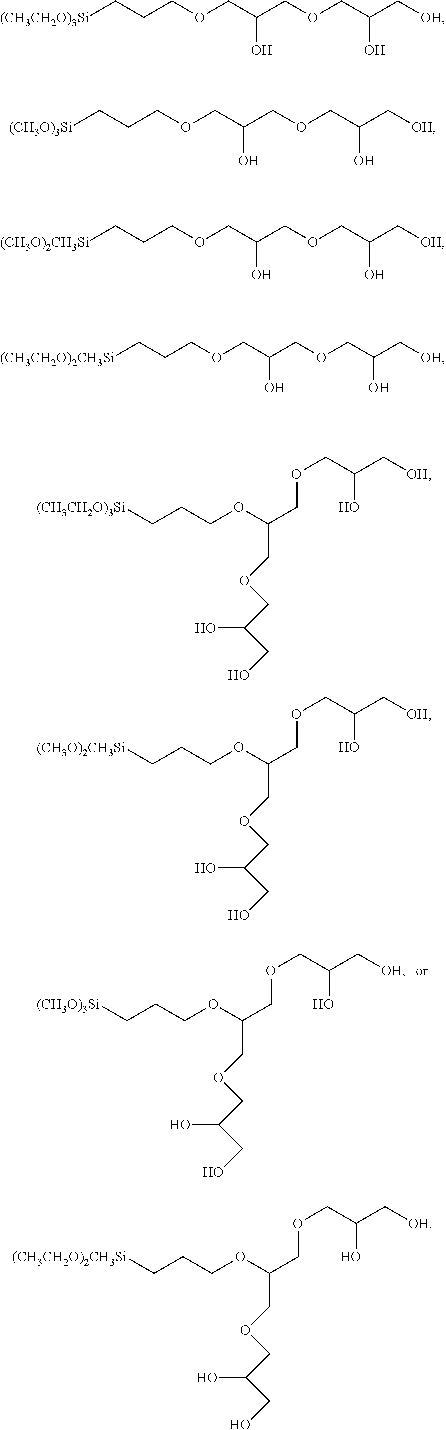

and those where A-Z is

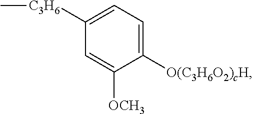

where c is ≥1, alternatively 1-5 alternatively 2-4, alternatively 2, alternatively 3, and X is trimethoxysilyl, triethoxysilyl, tripropoxysilyl, methyldimethoxysilyl, ethyldiethoxysilyl, ethyldimethoxysilyl, methyldiethoxysilyl, dim ethylmethoxysilyl, diethyldiethoxysilyl, diethylmethoxysilyl, or dimethylethoxysilyl.

One embodiment of the invention is a composition comprising the organosilane described above. A “composition,” with respect to the organosilane is the organosilane itself and one additional material. Example of additional materials include solvents, surfactants, additives, acids, bases, oils, emollients, waxes, conditioners such as cationic, amphoteric, and betaine conditioning agents, opacifiers, suncreens, and metal oxides.

### Method of Preparing an Organosilane (A)

A method for preparing an organosilane, the method comprising reacting an organic compound Z¹-E¹, wherein Z is a sugar, a monoglycerol group, a diglycerol, a polyglycerol, or a xylitol group, E¹ is hydroxyl, amine or an organic group comprising a reactive functional group, where the reactive functional group comprises hydroxyl, amine, oxirane, or isocyanate, with an organic compound D¹-E², wherein D¹ is an organic group comprising an unsaturated hydrocarbyl group having 2 to 12 carbon atoms, and E² is a reactive functional group comprising hydroxyl, amine, oxirane, or isocyanate, at a temperature and pressure sufficient to cause Z¹-E¹ and D¹-E² to react, to form F¹, wherein F¹ is an intermediate, and

reacting F¹ with an organosilane of formula Si(OR¹)ₙ(R²)₃₋ₙH, where R¹ is an alkyl group containing 1 to 4 carbon atoms and R² is an alkyl group containing 1 to 4 carbon atoms, n is from 1 to 3, and a hydrosilylation catalyst.
Organic Compound Z¹E¹

Z¹ represents a sugar, a monoglycerol group, a diglycerol group, a polyglycerol group, or a xylitol group, alternatively a diglycerol group, a polyglycerol group, or a xylitol, alternatively a diglycerol, a triglycerol group, or xylitol group. The sugar represented by Z¹ is as described above for the organosilane. In one embodiment, the sugar is glucose (D-glucose), fructose, or N-methyl glucamine, alternatively N-methylglucamine, alternatively D-glucose or N-methyl glucamine.

Monoglycerol, diglycerol and triglycerol groups represented by Z¹ are represented by the formula Glyₐ, wherein Gly is R³CH₂CH(R³)CH₂R³, where each R³ independently represents hydroxyl, an oxygen atom linking to E¹, or an oxygen atom linking to another Gly unit, and a is an integer ≥1, alternatively a is an integer ≥2, alternatively an integer from 2 to 6, alternatively 2 or 3, alternatively 2, alternatively 3. In one embodiment, Glyₐ represents —OCH₂CH(OH)CH₂OCH₂CH(OH)CH2OH, —OCH(CH₂OCH₂CH(OH)CHOH)CH₂OCH₂CH(OH)CH₂OH, or —O(C3H6O2)_{b}H, where b is greater than 1, alternatively greater than 2, alternatively from 2 to 8, alternatively from 2 to 6, alternatively 2 or 3, alternatively 2 alternatively 3, alternatively Glyₐ represents —OCH₂CH(OH)CH₂OCH₂CH(OH)CH2OH, or —OCH(CH₂OCH₂CH(OH)CHOH)CH₂OCH₂CH(OH)CH₂OH.

The xylitol group represented by Z¹ has the formula CH₂(R⁵)CH(R⁵)CH₂C(H)(R⁵)CH₂R⁵, where each R⁵ independently represents hydroxyl or an oxygen atom linking to E¹. In one embodiment, the xylitol group is —OCH₂CH(OH)CH₂C(H)(OH)CH₂OH.

The amine group represented by E¹ typically is a primary or secondary amine, alternatively a pimary amine. The group bonded to the secondary amine is typically a hydrocarbyl group having from 1 to 10 carbon atoms, alternatively 1 to 6 carbon atoms, alternatively 1 carbon atom. Examples of hydrocarbyl groups of the secondary amine include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and napthyl; alkaryl, such as tolyl and xylyl; aralkyl, such as benzyl and phenethyl; alkenyl, such as vinyl, allyl, and propenyl; aralkenyl, such as styryl and cinnamyl; and alkynyl, such as ethynyl and propynyl.

The organic group comprising a reactive functional group represented by E¹ comprises hydroxyl, amine, oxirane, or isocyanate and typically comprises a hydrocarbyl group having from 1 to 10 carbon atoms, alternatively from 1 to 6 carbon atoms, alternatively 1 to 3 carbon atoms, wherein the hydrocarbyl group is substituted with hydroxyl, amine, oxirane, or isocyanate. Examples of hydrocarbyl groups of the organic group comprising a reactive functional group include, but are not limited to, alkyl, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl; cycloalkyl, such as cyclopentyl, cyclohexyl, and methylcyclohexyl; aryl, such as phenyl and napthyl; alkaryl, such as tolyl and xylyl; aralkyl, such as benzyl and phenethyl; alkenyl, such as vinyl, allyl, and propenyl; aralkenyl, such as styryl and cinnamyl; and alkynyl, such as ethynyl and propynyl.

Examples of the organic group comprising a hydroxyl group represented by E¹ include, but are not limited to, hydroxyalkyl, such as hydoxymethyl, hydroxyethyl. hydroxypropyl, hydroxybutyl, hydroxypentyl, hydroxyhexyl, hydroxyl dodecyl.

The amine comprised by the organic group comprising a reactive functional group is as defined for E¹ above. The oxirane group of the organic group comprising a reactive functional group is a hydrocarbyl group means a compound in which an oxygen atom is directly attached to two adjacent carbon atoms of a carbon chain or ring system ((i.e, a three member cyclic ether), and is represented by the following structural formula —CH(O)CH₂. Example of the organic group comprising an oxirane functional group include, but are not limited to, alkenyl oxide, such as ethenyl oxide, propenyl oxide, 1-butenyl oxide, 1-pentenyl oxide, 1-hexenyl oxide, 1-septenyl oxide, 1-octenyl oxide; and cycloalkenyl oxide, such as cyclohexenyl oxide. Oxirane functionality is represented in formulas using the structure —CH(O)CH₂.

The isocyanate group has the structure —N═C═O, where the isocyanate is bonded or linked through the nitrogen atom. Examples of the organic group comprising isocyante include alkly isocyanates, such as methyl, ethyl, propyl, 1-methylethyl, butyl, 1-methylpropyl, 2-methylpropyl, 1,1-dimethylethyl, pentyl, 1-methylbutyl, 1-ethylpropyl, 2-methylbutyl, 3-methylbutyl, 1,2-dimethylpropyl, 2,2-dimethylpropyl, hexyl, heptyl, octyl, nonyl, and decyl, wherein the alkyl group is substituted with an isocyanate group; cycloalkyl, such as cyclopentyl, cyclohexyl, and methylcyclohexyl, wherein the cycloalkyl group is substituted with an isocyanate group; aryl, such as phenyl and napthyl wherein the aryl group is substituted with an isocyanate group; alkaryl, such as tolyl and xylyl, wherein the alkaryl group is substituted with an isocyanate group; aralkyl, such as benzyl and phenethyl, wherein the aralkyl group is substituted with an isocyanate group; alkenyl, such as vinyl, allyl, and propenyl, wherein the alkenyl group is substituted with an isocyanate group; aralkenyl, such as styryl and cinnamyl, wherein the aralkenyl group is substituted with an isocyanate group; and alkynyl, such as ethynyl and propynyl, wherein the alkynyl group is substituted with an isocyanate group.

Examples of the organic compound Z¹E¹ include, but are not limited to, 2,3-epoxypropyldiglycerol, 2,3-epoxypropyltriglycerol, 2,3-epoxypropylpolyglycerol, N-2,3-epoxypropyl-N-methylglucamine, 3-aminopropyldiglycerol, 3-aminopropyltriglycerol, 3-aminopropylpolyglycerol, N-3-aminopropyl-N-methylglucamine, 3-isocyanatopropyldiglycerol, 3-isocyanatopropyltriglycerol, 3-isocyanatopropylpolyglycerol, N-3-icocyanatopropyl-N-methylglucamine, glycerol, diglycerol, triglycerol, polyglycerol, and N-methylglucamine. Compounds according to formula Z¹E¹ may be purchased commercially or synthesized from readily available starting materials using reactions known in the art. For example, methods of synthesizing these materials can be found in Japanese Patent docoments JP2001-261672 A1 and JP2004-277548 A1, both of which are hereby incorporated by reference for their teaching related to synthesizing compounds according to the formula Z¹E¹.

Organic Compound D¹E²

The organic group represented by D¹ typically comprises an unsaturated hydrocarbyl group having 2 to 12 carbon atoms, alternatively 2 to 11 carbon atoms, alternatively from 3 to 10 carbon atoms, alternatively from 3 to 6 carbon atoms, alternatively 3 or 4 carbon atoms, alternatively 3 carbon atoms. Examples of unsaturated hydrocarbyl groups represented by D¹ include, but are not limited to, alkenyl, such as vinyl, allyl, and butenyl; aralkenyl, eugenyl, styryl and cinnamyl; and alkynyl, such as ethynyl and propynyl aryl, such as phenyl and napthyl; alkaryl, such as tolyl and xylyl; aralkyl, such as benzyl and phenethyl;.

The reactive functional groups represented by E² comprise hydroxyl, amine, oxirane, or isocyanate. The hydroxyl, amine, oxirane and isocyanate groups are as described above for E¹.

Examples of compounds represented by D¹E² include, but are not limited to, allyl alcohol, 3-buten-1-ol, 4-penten-1-ol, 5-hexen-1-ol, 6-septen-1-ol, 11-dodecen-1-ol, eugenol, 3-amino-1-propene, 4-amino-1-butene, 5-amino-1-pentene, 6-amino-1-hexene, 6-amino-1-cyclohexene, 12-amino-1-dodecene, 3,4-epoxy-1-butene, 1,2-epoxy-5-hexene, 1,2-epoxy-9-decene, allyl isocyanate, 1-isocyanato-3-butene, 1-isocyanato-4-pentene, 1-isocyanato-5-hexene, and phenylisocyanate. Many compounds represented by D¹E² are available commercially. Others may be synthesized using methods known in the art.

### Intermediate F¹

The intermediate F¹ is formed by the reaction of Z¹E¹ and D¹E². Examples of the intermediate represented by F¹ include, but are not limited to, the following compounds:

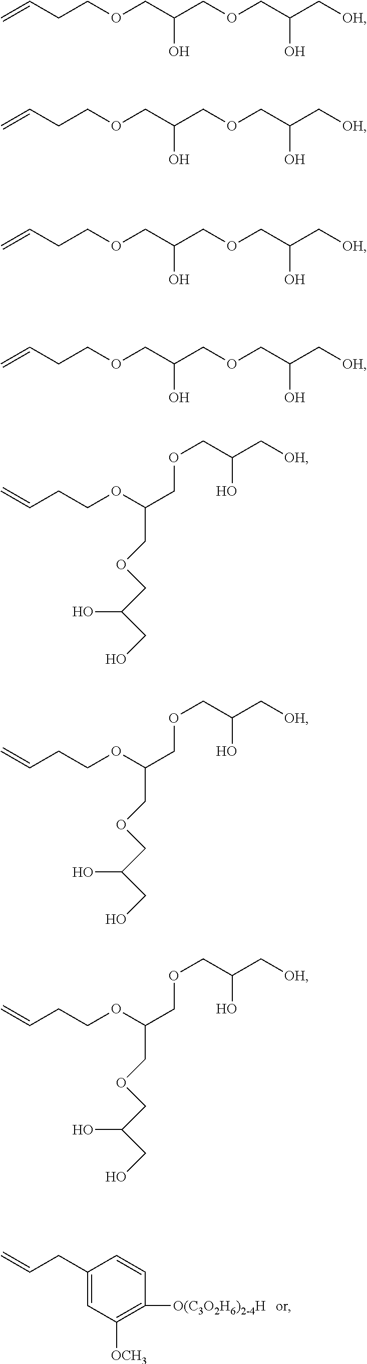

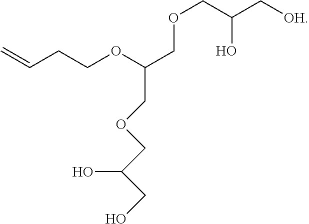 [SMILES: C=CCCOC(COCC(O)CO)COCC(O)CO]

The intermediate F¹ is reacted with an organosilane of formula Si(OR¹)ₙ(R²)₃₋ₙH, where R¹ is an alkyl group containing 1 to 4 carbon atoms and R² is an alkyl group containing 1 to 4 carbon atoms, n is from 1 to 3, alternatively 2 or 3, alternatively 1, alternatively 2, alternatively 3, and a hydrosilylation catalyst.

The alkyl groups represented by R¹ typically have from 1 to 4 carbon atoms, alternatively 1 or 2 carbon atoms, alternatively 1 carbon atom, alternatively 2 carbon atoms. Examples of hydrocarbyl groups represented by R¹ include, but are not limited to, methyl, ethyl, propyl, and butyl. The alkyl groups represented by R² are as defined for R¹.

The hydrosilylation catalysts can be any catalyst known to catalyze a hydrosilylation reaction between and compound containing an SiH group and a compound comprising an unsaturated hydrocarbon such as alkene or alkyne group. In one embodiment, the hydrosilylation catalyst comprises platinum. Examples of catalysts include compounds such as ruthenium, rhodium, palladium, osmium, iridium or the like. Examples of platinum compounds that may be used as catalysts comprise chloroplatinic acid, platinum metal, a platinum metal-supported carrier such as platinum-supported alumina, platinum-supported silica, platinum-supported carbon black or the like. Platinum complexes such as platinum-vinylsiloxane complex, platinum phosphine comples, platinu-phosphited comples, platinum alcholate catalyst or the like may also be used. An effective amount of catalyst is used. As used herein “an effective amount of catalyst” is typically from 0.5 to 1,000 ppm as a platinum metal in the case of using a platinum catalysts.

Examples of organosilane compounds formed by the method of preparing an organosilane A include those of described above for formula (I).

### Method of Preparing an Organosilane (B)

A method for preparing an organosilane, the method comprising: reacting (a) an organosilane of formula Si(OR¹)ₙ(R²)₃₋ₙB¹, where R¹ is an alkyl group containing 1 to 4 carbon atoms and R² is an alkyl group containing 1 to 4 carbon atoms, n is from 1 to 3, and B¹ is an organic group comprising a reactive functional group, where the reactive functional group comprises hydroxyl, amine, oxirane, or isocyanate, and (b) an organic compound Z¹-E¹, wherein Z is a sugar, a monoglycerol group, a diglycerol, a polyglycerol, eugenol, or a xylitol group, E¹ is hydroxyl, amine or an organic group comprising a reactive functional group, wherein the reactive functional group comprises hydroxyl, amine, oxirane, or isocyanate, at a temperature and pressure sufficient to cause (a) and (b) to react.

The groups represented by R¹ and R² in the organosilane reacted in method of preparing an organosilane B are as described above for method of preparing an organosilane A.

Organic groups comprising a reactive group represented by B¹ include, but are not limited to hydrocarbyl groups having from 1 to 10 carbon atoms, alternatively, 1 to 7 carbon atoms, alternatively 1 to 3 carbon atoms, wherein the hydrocarbyl group is substituted with the reactive group. Examples of hydrocarbyl groups include eugenol, where the non-aromatic olefin (i.e., terminal unsaturation) is replaced by a terminal bond to the silicon atom of the organosilane, alkyl, such as methyl, ethyl, propyl, butyl, hexyl, octyl, and decyl. The backbone of the hydrocarbyl group may be substituted with one or more of the following atoms and/or groups: oxygen, nitrogen, carbonyl, carboxyl, amide, and ureylene, alternatively, the backbone of the hydrocarbyl group is substituted with one or more of the following atoms and/or groups: oxygen, nitrogen, carbonyl, carboxyl, amide, and ureylene, alternatively oxygen, alternatively nitrogen.

The reactive group of the organic group B¹ is hydroxyl, amine, oxirane, or isocyanate. The reactive functional group is as described for method of preparing an organosilane A above. B¹ may be the hydrosilylation reaction product of an organohydridosilane of formula Si(OR¹)ⁿ(R²)₃₋ₙH with D¹E² above, wherein R¹, R², and n are as defined above.

The organic compound E¹Z¹ and the groups E¹and Z¹ are as defined above for method of preparing an organosilane A.

Examples of organosilane compounds formed by the method of preparing an organosilane B include those of described above for formula (I).

Method of preparing an organosilane A and method of preparing an organosilane B for preparing the organosilane described above are conducted at a temperature sufficient to cause the reactions to take place. A temperature sufficient to cause the reaction to place is from 25 C to 300 C, alternatively from 40 C to 150 C, alternatively from 65 C to 120 C.

Method of preparing an organosilane A and method of preparing an organosilane B for preparing an organosilane described above are conducted at a pressure sufficient for the reaction to take place. A pressure sufficient for the reaction to take place means a pressure from atmospheric pressure to a pressure above atmospheric pressure, alternatively at atmospheric pressure, alternatively at a pressure above atmospheric pressure, alternatively at a pressure from 0 to 100 kPa gauge pressure, alternatively at a pressure from 10 kPa to 100 kPa.

Method of preparing an organosilane A and method of preparing an organosilane B for preparing an organosilane described above are conducted for a time sufficient for the reaction to take place. One skilled in the art will understand that the time sufficient for the reaction to take place will vary with the temperature and the pressure of the reaction. Typically a time sufficient for the reaction is at least 10 minutes, alternatively from 30 minutes to 20 hours, alternatively from 2 to 10 hours.

Method of preparing an organosilane A and method of preparing an organosilane B described above for preparing an organosilane may be conducted in any reactor typically used for chemical reactions at elevated temperate such as a three neck glass flask, a column, sealed tube, film, such as a thin film or falling film reactor. One skilled in the art would know how to select an appropriate reactor to conduct the method for preparing the organosilane.

Method of preparing an organosilane A and method of preparing an organosilane B may further comprise the step if recovering the organosilane produced by the methods. The recovering may be accomplished by methods known in the art such as distillation.

Method of preparing an organosilane A and method of preparing an organosilane B provide cost effective methods of producing the compounds of formula (I) described above with good efficiency and yield.

The organosilanes of formula (I) described above and produced by method of preparing an organosilane A or method of preparing an organosilane B can be used in many applications and provide benefits including, but not limited to, improved dispersibility of powders, transmittance, antifog and antifouling coatings.

Method of forming a polysiloxane, the method comprising: hydrolyzing and condensing the organosilane of formula (I) or the organosilane produced according to method of preparing an organosilane A or method of preparing an organosilane B described above to form the polysiloxane. One skilled in the art would know how to hydrolyze and/or condense the organosilane of formula (I) or the organosilane produced according to method of preparing an organosilane A or method of preparing an organosilane B described above to produce a polysiloxane. As used herein, “polysiloxane” includes dimers, trimers, oligomers, and polymers containing an Si—O—Si bond produced by the hydrolysis and condensation of the organosilane.

A treatment composition comprising the product of the hydrolysis and/or condensation of the organosilane of formula (I) or of the organosilane produced by method of preparing an organosilane A or method of preparing an organosilane B. The treatment composition further comprises at least one additional ingredient. Examples of the at least one additional ingredient include, but are not limited to, a solvent, an inorganic oxide, an emollient, a surfactant, an oil, an ester, a polymer, a pigment, a base, or an acid.

A method of treating a surface comprising applying the organosilane of formula (1), the organosilane produced according the method of producing an organosilane A, or the organosilane produced according the method of producing an organosilane B to a surface. The organosilane of formula (1), the organosilane produced according to the method of producing an organosilane A, an the organosilane produced according the method of producing an organosilane B are as described above. One skilled in the art would know how to apply an organosilane to a surface to treat the surface.

A hydrophilized substrate having on its surface a surface treatment layer comprising the oganolsilane of formula (1), the organosilane produced according the method of producing an organosilane A, or the organosilane produced according the method of producing an organosilane B, where the organosilane of formula (1), the organosilane produced according the method of producing an organosilane A, or the organosilane produced according the method of producing an organosilane B are as described above.

Examples of the hydrophilized substrate include, but are not limited to, a powder, alternatively a metal oxide; glass; pigment; keratinous materials, alternatively skin, alternatively hair; fabrics, alternatively wool, nylon, or rayon, alternatively wool. Examples of the metal oxide include, but are not limited to, zinc oxide or titanium dioxide. Zinc oxide and titanium dioxide are available commercially.

A cosmetic composition, wherein the cosmetic composition comprises the hydrophilized powder. Examples of cosmetics include, but are not limited to, color cosmetics, skin lotions, sunscreen lotions, eye makeup, and foundation. Methods of making cosmetics comprising the hydrophilized powder are known in the art. One skilled in the art would know how to incorporate hydrophilized powders into cosmetic compositions.

Purity of the organosilane may be determined by ²⁹Si-NMR, reverse phase liquid chromatography or, more likely, by gas chromatography (GC) as described later. For example, the purity determined by GC may be from 60 area % to 100 area % (GC), alternatively from 70 area % to 100 area % (GC), alternatively from 80 area % to 100 area % (GC), alternatively from 90 area % to 100 area % (GC), alternatively from 93 area % to 100 area % (GC), alternatively from 95 area % to 100 area % (GC), alternatively from 97 area % to 100 area % (GC), alternatively from 99.0 area % to 100 area % (GC). Each 100 area % (GC) independently may be as defined previously.

### EXAMPLES

The invention is further illustrated by, and an invention embodiment may include any combinations of features and limitations of, the non-limiting examples thereof that follow. Ambient temperature is about 23° C. unless indicated otherwise.

²⁹Si-NMR instrument and solvent: a Varian 400 MHz Mercury spectrometer is used. C₆D₆ is used as the solvent.

### Example 1

In a 500 ml three neck round bottom flask was added 125.0 g (0.65 mole) of allyl xylitol. The reaction flask was fitted with a mechanical stirrer, reflux condenser, addition funnel, heating mantle and a thermocouple and the entire apparatus was placed under a N₂ blanket. Then 79.4 g (0.75 moles) of dimethoxymethylsilane was added to the addition funnel. The contents of the flask was heated to 50° C.±2° C. Next, 1% Dow Corning® 2-0707 INT catalyst in toluene was added (resulting in 4 ppm Pt at the end of the reaction). After the exotherm had subsided, the remaining dimethoxymethylsialne was slowly added so the temperature of the reaction never went above 58° C. Complete addition took approximately two hours and then the reaction was maintained at 50° C. for an additional 4 hours. Next, the reaction vessel was swept with N₂ for 4 hours. The clear product was analyzed by ²⁹Si, ¹³C and ¹H NMR. These methods indicated that the desired reaction had taken place and that no side reactions with the alkoxy groups had occurred.

### Example 2

Hydrosilylation of Allyl Diglycerol with Dimethoxymethylsilane

In a 500 ml three neck round bottom flask was added 125.0 g (0.61 mole) of allyl diglycerol. The reaction flask was fitted with a mechanical stirrer, reflux condenser, addition funnel, heating mantle and a thermocouple and the entire apparatus was placed under a N₂ blanket. Then 74.0 g (0.70 moles) of dimethoxymethylsilane was added to the addition funnel. The contents of the flask was heated to 50° C.±2° C. Next, 1% Dow Corning® 2-0707 INT catalyst in toluene was added (resulting in 4 ppm Pt at the end of the reaction). After the exotherm had subsided, the remaining dimethoxymethylsialne was slowly added so the temperature of the reaction never went above 58° C. Complete addition took approximately two hours and then the reaction was maintained at 50° C. for an additional 4 hours. Next, the reaction vessel was swept with N₂ for 4 hours. The clear product was analyzed by ²⁹Si, ¹³C and ¹H NMR. These methods indicated that the desired reaction had taken place and that no side reactions with the alkoxy groups had occurred.

### Example 3

Reaction of (3-glycidoxypropyl)dimethoxymethyl Silane with Xylitol

In a 500 ml three neck round bottom flask is added 72.4 g (0.33 mole) of (3-glycidoxypropyl)dimethoxymethyl silane, 50.0 g (0.33 mole) of xylitol and 50.0 g of toluene. The flask is equipped with a mechanical stirrer, a reflux condenser and a thermocouple and placed under a N₂ atmosphere. The mixture is heated to and maintained at 85°±5° C. for 10 hours with mixing. The crude product is then heated to 110°±5° C. and placed under a 5 mmHg atmosphere for 2 hours. The resulting product is analyzed by ²⁹Si, ¹³C and ¹H NMR. These methods will indicate that the desired reaction had taken place and that no side reactions with the alkoxy groups has occurred.

### Example 4

Reaction of (3-isocyanato)methyldimethoxy Silane with a Xylitol

In a 500 ml three neck round bottom flask is added 62.5 g (0.33 mole) of (3-isocyanatopropyl)dimethoxymethyl silane, 50.0 g (0.33 mole) of xylitol and 50.0 g of toluene. The flask is equipped with a mechanical stirrer, a reflux condenser and a thermocouple and placed under a N₂ atmosphere. The mixture is heated to and maintained at 85°±5° C. for 10 hours with mixing. The crude product is then heated to 110°±5° C. and placed under a 5 mmHg atmosphere for 2 hours. The resulting product is analyzed by ²⁹Si, ¹³C and ¹H NMR. These methods will indicate that the desired reaction had taken place and that no side reactions with the alkoxy groups has occurred.

### EMBODIMENTS OF THE INVENTION

In a first embodiment, an organosilane has formula (I)

(I) X-A-Z,

wherein X is —SiR⁴ₙR²₃₋ₙ), where each R⁴ is independently OR¹ or halogen, wherein each R¹ is independently hydrogen or C₁₋₁₀ hydrocarbyl and each R² is independently C₁₋₁₀ hydrocarbyl, and n is from 1 to 3, A is C₁₋₁₀ hydrocarbylene, wherein the backbone of the hydrocarbylene is substituted and the substitution comprises one or more oxygen atoms, one or more nitrogen atoms, or carbonyl, Z is a sugar group, a diglycerol group, a polyglycerol group, or a xylitol group.

In a second embodiment, the organosilane of the first embodiment, wherein Z is a diglycerol or polyglycerol group represented by Glyₐ, wherein Gly is R³CH₂CH(R³)CH₂R³, where each R³ independently represents hydroxyl, an oxygen atom linking to A, or an oxygen atom linking to another Gly unit, and a is an integer ≥2, or a xylitol group represented by Xyl, wherein Xyl is CH₂(R⁵)CH(R⁵)CH₂C(H)(R⁵)CH₂R⁵, where each R⁵ independently represents hydroxyl or an oxygen atom linking Xyl to A.

In a third embodiment, the organosilane of the first embodiment, wherein the alkylene backbone of A is substituted with one or two oxygen atom, one nitrogen atom, —NC(O)O—, —NC(O)N—, or wherein A is a substituted C₁₋₁₀ hydrocarbylene represented by the following structure

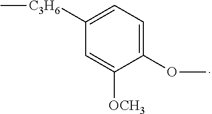

In a fourth embodiment, the organosilane of the first embodiment, wherein A is substituted with —OH or —CH₂OH.

In a fifth embodiment, the organosilane as in any one of the preceding embodiments, wherein R¹ is ethyl or methyl, R² is methyl, n is 2 or 3, A is propylene and A may be substituted with —OH or —CH₂OH.

In a sixth embodiment, the organosilane of the first embodiment, wherein —A-Z is selected from —C₃H₆O(C₃H₆O₂)_{b}H, wherein b is an average of 3 or 4, and

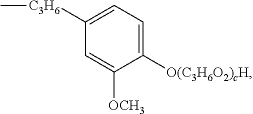

wherein c is greater than or equal to 1, b is an average of 4, or wherein the organosilane is according to the formula

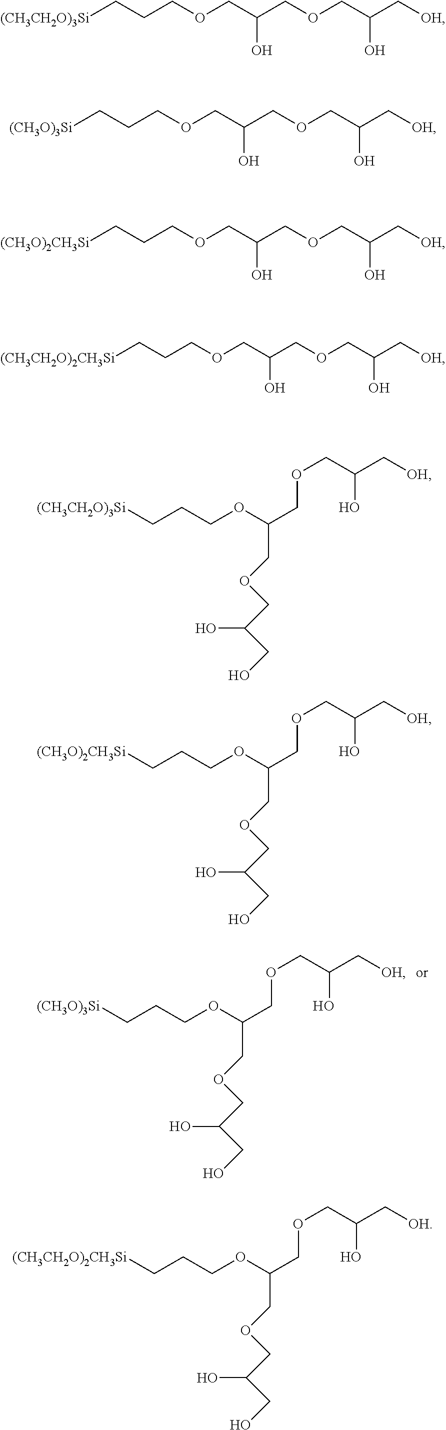

In a seventh embodiment, the organosilane according to the first embodiment, wherein Z is N(R⁷)(CH₃)CH₂[C(H)(R⁶)]₄CH₂(R⁶), wherein each R⁶ independently represents hydroxyl or an oxygen atom linking to A, and R⁷ represents a hydrogen atom, hydrocarbyl, or a bond to A.

In an eighth embodiment, the organosilane according to the seventh embodiment, wherein R¹ is ethyl, n=3, A is —(CH₂)₃OCH₂CH(OH)CH₂—, and Z is —N(CH₃)CH₂[C(H)(OH)]₄CH₂(OH).

In a ninth embodiment, a composition comprises the organosilane of any one of the preceding embodiments.

In a tenth embodiment, a method for preparing an organosilane comprises:

reacting an organic compound Z¹-E¹, wherein Z is a sugar, a monoglycerol group, a diglycerol, a polyglycerol, eugenol, or a xylitol group, E¹ is hydroxyl, amine or an organic group comprising a reactive functional group, where the reactive functional group comprises hydroxyl, amine, oxirane, or isocyanate, with an organic compound D¹-E², wherein D¹ is an organic group comprising an unsaturated hydrocarbyl group and 2 to 12 carbon atoms, and E² is a reactive functional group comprising hydroxyl, amine, oxirane, or isocyanate, at a temperature and pressure sufficient to cause Z¹-E¹ and D¹-E² to react, to form F¹, wherein F¹ is an intermediate, and

reacting F¹ with an organosilane of formula Si(OR¹)ₙ(R²)₃₋ₙH, where R¹ is an alkyl group containing 1 to 4 carbon atoms and R² is an alkyl group containing 1 to 4 carbon atoms, n is from 1 to 3, and a hydrosilylation catalyst.

In an eleventh embodiment, the method of the tenth embodiment, wherein Z¹ is a diglycerol or polyglycerol group represented by Glyₐ, wherein Gly is R³CH₂CH(R³)CH₂R³, where each R³ independently represents hydroxyl, an oxygen atom linking to E¹, or an oxygen atom linking to another Gly unit, and a is an integer ≥2, or a xylitol group represented by Xyl, wherein Xyl is CH₂(R⁵)CH(R⁵)CH₂C(H)(R⁵)CH₂R⁵, where each R⁵ independently represents hydroxyl or an oxygen atom linking Xyl to E¹.

In a twelfth embodiment, the method of the tenth embodiment, wherein Z is N(R⁷)(CH₃)CH₂[C(H)(R⁶)]₄CH₂(R⁶), wherein each R⁶ independently represents hydroxyl or an oxygen atom linking to E¹, and R⁷ represents a hydrogen atom, hydrocarbyl, or a bond to E¹.

In a thirteenth embodiment, the method of any one of the tenth through twelfth embdiments, wherein E¹ comprises an epoxy group and is represented by the formula—R⁸CH(O)CH₂, wherein R⁸ is a hydrocarblyene group having from 1 to 10 carbon atoms and E² is hydroxyl or amine, or wherein E¹ is hydroxyl, amine, or a hydrocarbyl group having from 1 to 10 carbon atoms, and further comprising a hydroxyl or amine group, and E² comprises an epoxy group and is represented by —R⁹CH(O)CH₂.

In a fourteenth embodiment, a method for preparing an organosilane comprises: reacting

(a) an organosilane of formula Si(OR¹)ₙ(R²)₃₋ₙB¹, where R¹ is an alkyl group containing 1 to 4 carbon atoms and R² is an alkyl group containing 1 to 4 carbon atoms, n is from 1 to 3, and B¹ is an organic group comprising a reactive functional group, where the reactive functional group comprises hydroxyl, amine, oxirane, or isocyanate, and

(b) an organic compound Z¹-E¹, wherein Z is a sugar, a monoglycerol group, a diglycerol, a polyglycerol, eugenol, or a xylitol group, E¹ is hydroxyl, amine or an organic group comprising a reactive functional group, wherein the reactive functional group comprises hydroxyl, amine, oxirane, or isocyanate,

at a temperature and pressure sufficient to cause (a) and (b) to react.

In a fifteenth embodiment, the method of the fourteenth embodiment, wherein Z¹ is a diglycerol or polyglycerol group represented by Glyₐ, wherein Gly is R³CH₂CH(R³)CH₂R³, where each R³ independently represents hydroxyl, an oxygen atom linking to E¹, or an oxygen atom linking to another Gly unit, and a is an integer ≥2, or a xylitol group represented by Xyl, wherein Xyl is CH₂(R⁵)CH(R⁵)CH₂C(H)(R⁵)CH₂R⁵, where each R⁵ independently represents hydroxyl or an oxygen atom linking Xyl to E¹.

In a sixteenth embodiment, the method of the fourteenth embodiment, wherein Z¹ is N(R⁷)(CH3)CH2[C(H)(R⁶)]₄CH₂(R⁶), wherein each R⁶ independently represents hydroxyl or an oxygen atom linking to E¹, and R⁷ represents a hydrogen atom, hydrocarbyl, or a bond to E¹.

In a seventeenth embodiment, the method of any one of the fourteenth through sixteenth embodiments, wherein the organic group in B¹ comprises an epoxy group and is represented by the formula R⁹CH(O)CH₂, wherein R⁹ is a hydrocarbylene group having 1 to 6 carbon atoms, and the backbone of R⁹ is substituted with an oxygen atom, and E¹ is hydroxyl, amine, R¹⁰OH, or R¹⁰NH₂, wherein R¹⁰ is a hydrocarbylene group having from 1 to 6 carbon atoms, or wherein B¹ comprises R¹⁰OH or R¹⁰NH₂ and E¹ comprises and epoxy group and is represented by the formula R⁹CH(O)CH₂.

In an eighteenth embodiment, a composition is prepared by the method of any one of the tenth through seventeenth embodiments.

In a ninteenth embodiment, a method of forming a polysiloxane comprises: condensing the organosilane of any one of the first through ninth embodiments or hydrolyzing and condensing the organosilane of any one of the first through ninth embodiments.

In a twentieth embodiment, a treatment composition comprises reaction products from the hydrolysis and/or condensation of the organosilane according to any of the first through eighth embodiments.

In a twenty-first embodiment a method of treating a surface comprises applying the composition according to any one of the eighteenth or twentieth embodiments to a surface.

In a twenty-second embodiment, a hydrophilized substrate has on its surface a surface treatment layer comprising

In a twenty-third embodiment, a hydrophilized substrate has on its surface a surface treatment layer comprising the organosilane of any one of the first through eighth embodiments.

In a twenty-fourth embodiment, the hydrophilized substrate of the twenty second embodiment, wherein the substrate is a powder.

In a twenty-fifth embodiment, the hydrophilized substrate of the twenty-third embodiment wherein the substrate is an inorganic powder.

In a twenty-sixth embodiment, the hydrophilized substrate of the twenty-fourth embodiment wherein the substrate is zinc oxide or titanium oxide.

In a twenty-seventh embodiment, a cosmetic comprising the powder of any one of the twenty-third through twenty-fifth embodiments.

In a twenty-eighth embodiment, the hydrophilized substrate of the twenty-second embodiment, wherein the substrate is a glass, metal oxides, pigments, keratinous materials, fabrics or skin.

1. An organosilane having formula (I)
(I) X-A-Z,
wherein X is —SiR⁴ₙR²₍₃₋ₙ₎, where each R⁴ is independently OR¹ or halogen, wherein each R¹ is independently C₁₋₁₀ hydrocarbyl and each R² is independently C₁₋₁₀ hydrocarbyl, and n is from 1 to 3, A is C₁₋₁₀ hydrocarbylene, wherein the backbone of the hydrocarbylene is substituted with one or two oxygen atom, one nitrogen atom, —NC(O)O—, —NC(O)N—, or wherein A is a substituted C₁₋₁₀ hydrocarbylene represented by the following structure 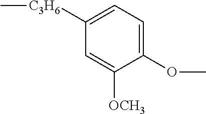
Z is a sugar group, a diglycerol group, a polyglycerol group, or a xylitol group.

2. The organosilane of claim 1, wherein Z is a diglycerol or polyglycerol group represented by Glyₐ, wherein Gly is R³CH₂CH(R³)CH₂R³, where each R³ independently represents hydroxyl, an oxygen atom linking to A, or an oxygen atom linking to another Gly unit, and a is an integer ≥2, or a xylitol group represented by Xyl, wherein Xyl is CH₂(R⁵)CH(R⁵)CH₂C(H)(R⁵)CH₂R⁵, where each R⁵ independently represents hydroxyl or an oxygen atom linking Xyl to A.

3. The organosilane as in claim 1, wherein A is substituted with —OH or —CH₂OH.

4. The organosilane as in claim 1, wherein R¹ is ethyl or methyl, R² is methyl, n is 2 or 3, A is propylene and A may be substituted with —OH or —CH₂OH.

5. The organosilane of claim 1, wherein —A-Z is selected from —C₃H₆O(C₃H₆O₂)_{b}H, wherein b is an average of 3 or 4, and 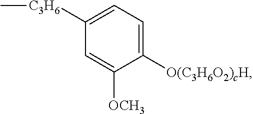
wherein c is greater than or equal to 1, b is an average of 4, or wherein the organosilane is according to the formula

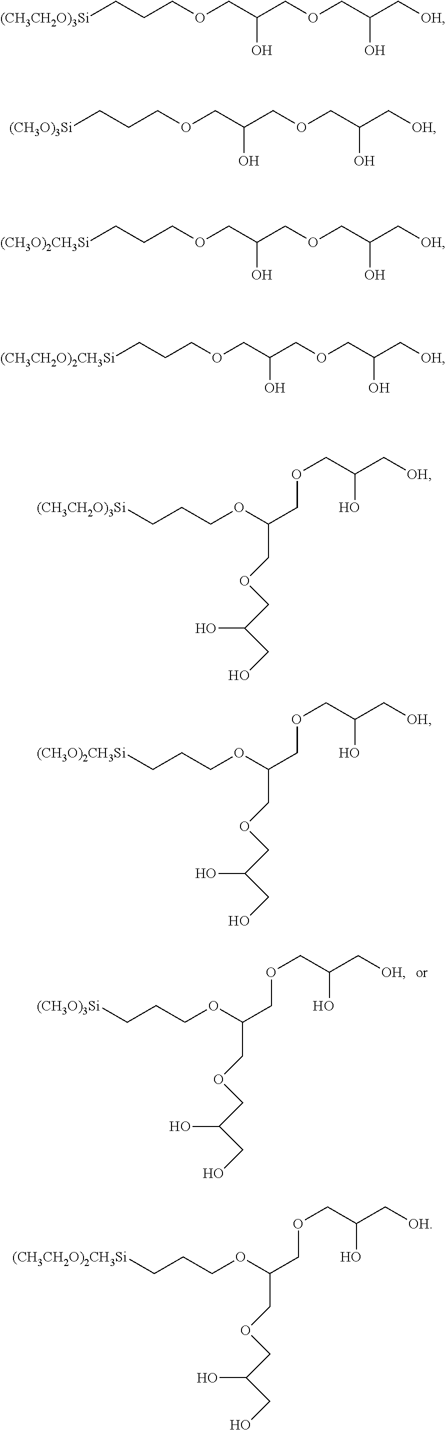

6. An organosilane according to claim 1, wherein Z is N(R⁷)(CH₃)CH₂[C(H)(R⁶)]₄CH₂(R⁶), wherein each R⁶ independently represents hydroxyl or an oxygen atom linking to A, and R⁷ represents a hydrogen atom, hydrocarbyl, or a bond to A.

7. The organosilane according to claim 6 wherein R¹ is ethyl, n=3, A is —(CH₂)₃OCH₂CH(OH)CH₂—, and Z is —N(CH₃)CH₂[C(H)(OH)]₄CH₂(OH).

8. A method for preparing an organosilane, the method comprising: reacting an organic compound Z¹-E¹, wherein Z is a sugar, a monoglycerol group, a diglycerol, a polyglycerol, eugenol, or a xylitol group, E¹ is hydroxyl, amine or an organic group comprising a reactive functional group, where the reactive functional group comprises hydroxyl, amine, oxirane, or isocyanate, with an organic compound D¹-E², wherein D¹ is an organic group comprising an unsaturated hydrocarbyl group and 2 to 12 carbon atoms, and E² is a reactive functional group comprising hydroxyl, amine, oxirane, or isocyanate, at a temperature and pressure sufficient to cause Z¹-E¹ and D¹-E² to react, to form F¹, wherein F¹ is an intermediate, and
reacting F¹ with an organosilane of formula Si(OR¹)ₙ(R²)₃₋ₙH, where R¹ is an alkyl group containing 1 to 4 carbon atoms and R² is an alkyl group containing 1 to 4 carbon atoms, n is from 1 to 3, and a hydrosilylation catalyst.

9. The method of claim 8, wherein Z is N(R⁷)(CH₃)CH₂[C(H)(R⁶)]₄CH₂(R⁶), wherein each R⁶ independently represents hydroxyl or an oxygen atom linking to E¹, and R⁷ represents a hydrogen atom, hydrocarbyl, or a bond to E¹.

10. The method of claim 8 or claim 9, wherein E¹ comprises an epoxy group and is represented by the formula —R⁸CH(O)CH₂, wherein R⁸ is a hydrocarblyene group having from 1 to 10 carbon atoms and E² is hydroxyl or amine, or wherein E¹ is hydroxyl, amine, or a hydrocarbyl group having from 1 to 10 carbon atoms, and further comprising a hydroxyl or amine group, and E² comprises an epoxy group and is represented by —R⁹CH(O)CH₂.

11. A method for preparing an organosilane, the method comprising: reacting
(a) an organosilane of formula Si(OR¹)ₙ(R²)₃₋ₙB¹, where R¹ is an alkyl group containing 1 to 4 carbon atoms and R² is an alkyl group containing 1 to 4 carbon atoms, n is from 1 to 3, and B¹ is an organic group comprising a reactive functional group, where the reactive functional group comprises hydroxyl, amine, oxirane, or isocyanate, and
(b) an organic compound Z¹-E¹, wherein Z is a sugar, a monoglycerol group, a diglycerol, a polyglycerol, eugenol, or a xylitol group, E¹ is hydroxyl, amine or an organic group comprising a reactive functional group, wherein the reactive functional group comprises hydroxyl, amine, oxirane, or isocyanate,
at a temperature and pressure sufficient to cause (a) and (b) to react.

12. The method of claim 8, wherein Z¹ is a diglycerol or polyglycerol group represented by Glyₐ, wherein Gly is R³CH₂CH(R³)CH₂R³, where each R³ independently represents hydroxyl, an oxygen atom linking to E¹, or an oxygen atom linking to another Gly unit, and a is an integer ≥2, or a xylitol group represented by Xyl, wherein Xyl is CH₂(R⁵)CH(R⁵)CH₂C(H)(R⁵)CH₂R⁵, where each R⁵ independently represents hydroxyl or an oxygen atom linking Xyl to E¹.

13. The method of claim 11, wherein Z¹ is N(R⁷)(CH3)CH2[C(H)(R⁶)]₄CH₂(R⁶), wherein each R⁶ independently represents hydroxyl or an oxygen atom linking to E¹, and R⁷ represents a hydrogen atom, hydrocarbyl, or a bond to E¹.

14. The method of claim 11, wherein the organic group in B¹ comprises an epoxy group and is represented by the formula R⁹CH(O)CH₂, wherein R⁹ is a hydrocarbylene group having 1 to 6 carbon atoms, and the backbone of R⁹ is substituted with an oxygen atom, and E¹ is hydroxyl, amine, R¹⁰OH, or R¹⁰NH₂, wherein R¹⁰ is a hydrocarbylene group having from 1 to 6 carbon atoms, or wherein B¹ comprises R¹⁰OH or R¹⁰NH₂ and E¹ comprises and epoxy group and is represented by the formula R⁹CH(O)CH₂.

15. The method of claim 11, wherein Z¹ is a diglycerol or polyglycerol group represented by Glyₐ, wherein Gly is R³CH₂CH(R³)CH₂R³, where each R³ independently represents hydroxyl, an oxygen atom linking to E¹, or an oxygen atom linking to another Gly unit, and a is an integer ≥2, or a xylitol group represented by Xyl, wherein Xyl is CH₂(R⁵)CH(R⁵)CH₂C(H)(R⁵)CH₂R⁵, where each R⁵ independently represents hydroxyl or an oxygen atom linking Xyl to E¹.

16. The method of claim 12, wherein the organic group in B¹ comprises an epoxy group and is represented by the formula R⁹CH(O)CH₂, wherein R⁹ is a hydrocarbylene group having 1 to 6 carbon atoms, and the backbone of R⁹ is substituted with an oxygen atom, and E¹ is hydroxyl, amine, R¹⁰OH, or R¹⁰NH₂, wherein R¹⁰ is a hydrocarbylene group having from 1 to 6 carbon atoms, or wherein B¹ comprises R¹⁰OH or R¹⁰NH₂ and E¹ comprises and epoxy group and is represented by the formula R⁹CH(O)CH₂.

17. The method of claim 13, wherein the organic group in B¹ comprises an epoxy group and is represented by the formula R⁹CH(O)CH₂, wherein R⁹ is a hydrocarbylene group having 1 to 6 carbon atoms, and the backbone of R⁹ is substituted with an oxygen atom, and E¹ is hydroxyl, amine, R¹⁰OH, or R¹⁰NH₂, wherein R¹⁰ is a hydrocarbylene group having from 1 to 6 carbon atoms, or wherein B¹ comprises R¹⁰OH or R¹⁰NH₂ and E¹ comprises and epoxy group and is represented by the formula R⁹CH(O)CH₂.
